(19) United States
(12) Patent Application Publication
(10) Pub. No.: US 2025/0236790 A1
(43) Pub. Date: Jul. 24, 2025

(54) MANGANESE-ACTIVATED NARROWBAND RED PHOSPHORS

(71) Applicant: Intematix Corporation, Fremont, CA (US)

(72) Inventors: Yi-Qun LI, Danville, CA (US); Shifan CHENG, San Jose, CA (US)

(21) Appl. No.: 18/420,150

(22) Filed: Jan. 23, 2024

Related U.S. Application Data
(60) Provisional application No. 63/479,726, filed on Jan. 12, 2023.

(51) Int. Cl. C09K 11/57; C09K 11/55; C09K 11/61; C09K 11/62; C09K 11/77

(52) U.S. Cl. CPC C09K 11/57; C09K 11/55; C09K 11/61; C09K 11/621; C09K 11/77068

(57) ABSTRACT

A light emitting device comprising: an excitation source for generating light with a dominant peak wavelength from about 430 nm to about 480 nm; and a manganese-activated narrowband red phosphor of general composition K₂TiF₆:Mn⁴⁺, wherein light generated by the light emitting device has a change of chromaticity CIE x of less than 0.006 after operating for at least 500 hours in an environment of temperature 60° C. and relative humidity 90% W (WHTOL 60° C./90% RH).

### CROSS REFERENCE TO RELATED APPLICATIONS

This application is a Utility application which claims the benefit of priority to U.S. Provisional application 63/479,726, filed Jan. 12, 2023, entitled “MANGANESE-ACTIVATED NARROWBAND RED PHOSPHORS”, and which is hereby incorporated by reference in its entirety.

### FIELD OF THE INVENTION

Embodiments of the invention concern manganese-activated narrowband red phosphor and in particular manganese-activated potassium titanium fluoride phosphor of general composition K₂TiF₆:Mn⁴⁺ (KTF). More particularly, although not exclusively, embodiments relate to light emitting devices for displays utilizing manganese-activated narrowband red phosphor.

### BACKGROUND OF THE INVENTION

Manganese-activated potassium silicon fluoride narrowband red phosphor (K₂SiF₆:Mn⁴⁺—KSF) has multiple narrowband red line emissions and has been adopted widely for LED packages used in LCD (Liquid Crystal Display) backlights to increase the color gamut of the display. However, the decay time of KSF, at 8 milliseconds, limits the backlight/display response frequency to about 125 Hz. For gaming applications, a display response frequency of 200 Hz and higher would be desirable.

Manganese-activated potassium titanium fluoride phosphor (KTF) has a decay time that is about 40% faster than KSF, about 5 milliseconds, indicating that a backlight/display incorporating KTF should have a response frequency of about 200 Hz. However, currently, there are no KTF products available in the commercial market due to the challenges in producing high efficacy and highly stable KTF. An object of the present invention is to overcome, at least in part, these limitations and provide a KTF phosphor having a comparable performance to that of KSF phosphor in terms of efficacy and reliability (stability) without experiencing the shortcomings of known methods and constructions and provide a backlight/display incorporating KTF having a response frequency that is greater than that of KSF.

### SUMMARY OF THE INVENTION

According to an aspect of the present invention, there is contemplated a light emitting device comprising: a source for generating light with a dominant peak wavelength in a range from about 430 nm to about 480 nm; and a manganese-activated narrowband red phosphor of general composition K₂TiF₆:Mn⁴⁺, wherein light generated by the light emitting device has a change of chromaticity CIE x of less than 0.006 after operating for at least 500 hours in an environment of temperature 60° C. and relative humidity 90%.

In terms of reliability (stability), light emitting devices in accordance with the invention that comprise K₂TiF₆:Mn⁴⁺ narrowband red phosphor have a reliability that is as good as light emitting devices that comprise, for instance, K₂SiF₆:Mn⁴⁺. Moreover, while the stability of both devices are similar, light emitting devices in accordance with the invention that comprise K₂TiF₆:Mn⁴⁺ narrowband red phosphor exhibit a much shorter decay time which is advantageous. The decay time of a light emitting device is determined by the slowest process of the device; in this instance, the decay time of the narrowband red phosphor. For example, K₂TiF₆:Mn⁴⁺ has a decay time of about 5 ms as compared with K₂SiF₆:Mn⁴⁺ which has a decay time of about 8 ms. For comparison, Eu activated green phosphors such as β-SiAlON:Eu or SrGa₂S₄:Eu have a decay time of a few tens of microseconds (μs) and quantum dots a decay time in the nanosecond range (ns). For this reason, light emitting devices in accordance with the invention that comprise K₂TiF₆:Mn⁴⁺ narrowband red phosphor have a decay time of about 5 ms making them ideally suited to applications in which the lighting device is turned on and off rapidly, such a displays for example.

It may be that the light generated by the light emitting device has a reduction in brightness of less than 10% after operating for at least 500 hours in said environment.

The light generated by the light emitting device may have a change of chromaticity CIE y of less than 0.005 after operating for at least 500 hours in said environment.

It may be that the manganese-activated narrowband red phosphor has a quantum efficiency of at least 90%, of at least 95%, or of at least 97%.

It is understood that that the improved reliability (stability) and quantum efficiency of the manganese-activated narrowband red phosphor (KTF) is due to improved particle crystallinity of the KTF resulting in stability/QE values that are comparable with those of KSF (K₂SiF₆:Mn⁴⁺). In embodiments the manganese-activated narrowband red phosphor comprises particles with a high degree of crystallinity, that is particles having clean facets (faces). The manganese-activated narrowband red phosphor may comprise particles with a regular shape, may be multi-faceted in form, and may, for example, be substantially polyhedron in shape. It may be that the manganese-activated narrowband red phosphor comprises particles of a size in a range from about 60 μm to about 120 μm.

The manganese-activated narrowband red phosphor may have a decay time of about 5 ms.

The light emitting device may comprise a narrowband green photoluminescence material selected from the group consisting of: β-SiAlON:Eu phosphor, SrGa₂S₄ phosphor, and green quantum dot material.

In accordance with another aspect, the present invention comprehends a display comprising a light emitting device as defined herein.

For example, it is contemplated that lighting devices according to the invention find utility as a display backlight in a display having zone dimming in which zones (regions) of backlights are modulated to achieve dimming. Moreover, lighting devices of the invention find utility as a light source for an individual pixel or sub-pixel in for example micro-LED and OLED displays. In micro-LED and OLED displays, red sub-pixels may comprise an LED and KTF.

It may be that the light emitting device comprises a display backlight. In this way, there is envisaged a display backlight comprising: an excitation source that generates light with a dominant peak wavelength from about 430 nm to about 480 nm; and a manganese-activated narrowband red phosphor of general composition K₂TiF₆:Mn⁴⁺, wherein light generated by the light emitting device has a change of chromaticity CIE x of less than 0.006 after operating for at least 500 hours in an environment of temperature 60° C. and relative humidity 90%. The display backlight may comprise a narrowband green photoluminescence material selected from the group consisting of: β-SiAlON:Eu phosphor, SrGa₂S₄ phosphor, and green quantum dot material.

The light emitting device may comprise a display pixel. The display pixel may comprise, for instance, a red sub-pixel for generating red light. It will be appreciated that such a red sub-pixel would comprise only an excitation source and a manganese activated narrowband red phosphor (that is without a green phosphor, for instance).

According to another aspect there is contemplated a display backlight comprising: a source for generating light with a dominant peak wavelength in a range from about 430 nm to about 480 nm; a manganese-activated narrowband red phosphor of general composition K₂TiF₆:Mn⁴⁺; and a narrowband green photoluminescence material selected from the group consisting of: β-SiAlON:Eu phosphor, SrGa₂S₄ phosphor, and green quantum dot material.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, in which:

FIG. 1 shows a schematic sectional side view of a packaged light emitting device comprising a single-layer photoluminescence structure;

FIG. 2 shows a schematic sectional side view of a packaged light emitting device comprising a double-layer photoluminescence structure;

FIG. 3 is a schematic sectional side view of a CSP (Chip Scale Packaged) light emitting device comprising a single-layer photoluminescence structure;

FIG. 4 is a schematic sectional side view of a CSP (Chip Scale Packaged) light emitting device comprising a double-layer photoluminescence structure;

FIG. 5 is an optical micrograph of particles of K₂TiF₆:Mn⁴⁺ (KTF);

FIG. 6 shows reliability data, change of chromaticity ΔCIE x, CIE x (t)-CIE x (0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross);

FIG. 7 shows reliability data, change of chromaticity ΔCIE y, CIE y (t)-CIE y (0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross); and

FIG. 8 shows reliability data, relative brightness, Brightness (t)-Brightness (0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross).

### DETAILED DESCRIPTION OF THE INVENTION

Embodiments of the present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

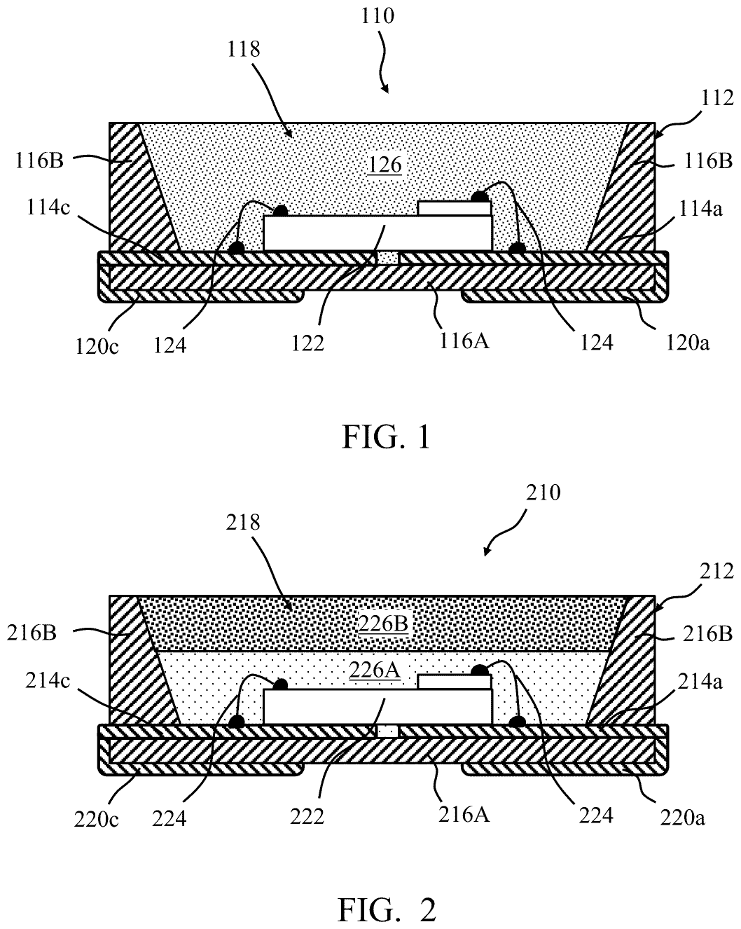

Throughout this specification like reference numerals are used to denote like parts preceded by the figure number #. For example, a light emitting device is denoted 110 in FIG. 1 is denoted 210 in FIG. 2 and so forth.

A packaged white light emitting device 110 in accordance with an embodiment of the invention will now be described with reference to FIG. 1 which shows a schematic sectional side view of the device 110 which comprises a single-layer photoluminescence structure. The light emitting device 110, as illustrated, may comprise a SMD (Surface Mounted Device) such as for example a 2835 LED package.

The light emitting device 110 comprises a package 112 comprising a lead frame 114a, 114c onto which a housing 116A, 116B is molded. The housing 116A, 116B comprises a base portion 116A and side wall portions 116B that extend upwardly from opposing edges of the base portion 116A. The interior surfaces of the side wall portions 116B slope inwardly to their vertical axis in a direction towards the base and, together with the interior surface (floor) of the base portion 116A, define a cup (cavity, recess) 118 in the shape of an inverted frustum of a pyramid or inverted frustrum of a conc. The lead frame comprises anode 114a and cathode 114c regions on the floor of the cup.

As shown, portions of the anode lead frame region 114a and cathode lead frame region 114b may extend laterally to the outside edges of the housing 116 and form respective electrical anode and cathode terminals 120a, 120c on an underside of the package along opposing edges of the package 112 allowing electrical power to be applied to the anode (A) and cathode (C) of each LED chip.

The cup 118 contains one or more InGaN-based LED dies (chips) 122 mounted on the floor (interior surface of the base) of the cavity 118. The LED chip(s) generate light with a dominant peak wavelength from about 430 nm to about 480 nm. As indicated, the LED chip(s) 122 can be electrically connected to the anode lead frame 114a and cathode lead frame 114c regions by bond wires 124.

The cup (cavity) 118 is filled with a photoluminescence material layer 126 comprising a combination of a narrowband red phosphor and a narrowband green photoluminescence material. It will be understood, however, that in other embodiments the photoluminescence material layer 126 may comprise only the narrowband red phosphor. The photoluminescence material layer 126 may comprise a light transmissive (transparent) optical encapsulant, such as silicone material, with the narrowband red phosphor and narrowband green photoluminescence materials incorporated therein. In accordance with the invention, the narrowband red phosphor is a manganese activated potassium fluorotitanate phosphor of general composition K₂TiF₆:Mn⁴⁺. The narrowband green photoluminescence material may comprise a narrowband green phosphor, such as for example β-SiAlON:Eu phosphor or SrGa₂S₄ phosphor, or a Quantum Dot material or combinations thereof.

The device 110 can be manufactured by dispensing a curable light transmissive liquid material, silicone for example, containing a mixture of the narrowband red phosphor and narrowband green photoluminescence material to fill the cup (cavity) 118.

While in the foregoing, the narrowband red phosphor and narrowband green photoluminescence material can comprise a mixture in a single photoluminescence material layer (single-layer photoluminescence structure), in other embodiments the narrowband red phosphor and narrowband green photoluminescence material may be provided in a respective layer. FIG. 2 shows a schematic sectional side view of a packaged white light emitting device 210 in accordance with an embodiment in which the narrowband red phosphor and narrowband green photoluminescence material is in a respective layer 226A, 226B (double-layer photoluminescence structure). As illustrated, the first photoluminescence material layer 226A containing the narrowband red phosphor is located proximal to the LED die(s) 222 and the second photoluminescence material layer 226B containing the narrowband green photoluminescence material is located on top of the first photoluminescence material layer 226A and is distal to the LED die(s) 222. The double-layer photoluminescence structure in which different phosphors/photoluminescence materials are located in different layers is beneficial where the phosphors/photoluminescence materials have differing blue light absorption efficiencies (capabilities). For example, K₂TiF₆:Mn⁴⁺ narrowband red phosphor has a much lower blue light absorption efficiency than β-SiAlON:Eu narrowband green phosphor or SrGa₂S₄ narrowband green phosphor. Therefore, having the K₂TiF₆:Mn⁴⁺ narrowband red phosphor in the layer closest (proximal) to the LED die(s) 222 (chip) allows the red phosphor to absorb more blue light from the LED die(s) 222 without competition from the narrowband green photoluminescence material (which is in a separate layer). Any unconverted blue light can thus pass to the neighboring second photoluminescence material layer 226B and be absorbed by the narrowband green photoluminescence material located therein which may have a higher absorption efficiency than K₂TiF₆:Mn⁴⁺.

While the foregoing embodiments have been described in relation to packaged, embodiments of the invention find utility for Chip Scale Packaged light emitting devices. In this specification, a CSP arrangement is a packaging arrangement on a chip scale and does not include a lead frame. In a CSP arrangement, the LED chip may comprise an integral component of the package. For example, one or more layers of material can be applied directly to a light emitting face, or faces, of an LED flip chip to form a packaged device. A particular advantage of a CSP arrangement is the small size of the packaged device, which may be comparable to the chip size.

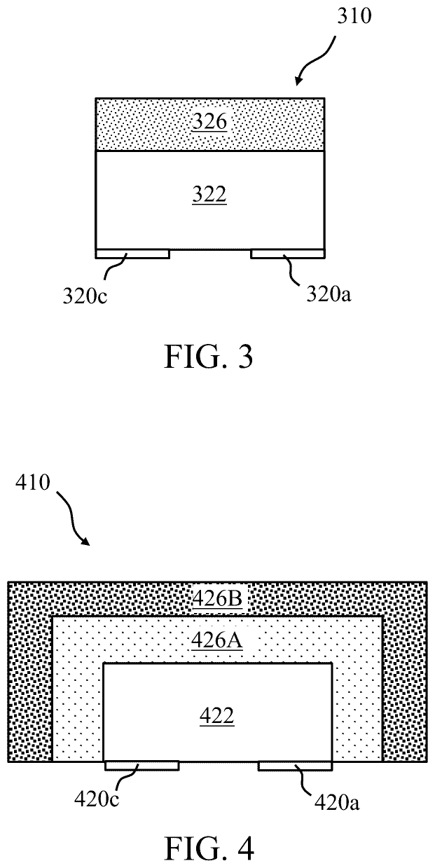

FIG. 3 show a side view of a single-layer photoluminescence structure CSP light emitting device 310 in accordance with embodiment of the invention. In this embodiment, a photoluminescence layer 326, containing a narrowband red phosphor and a narrowband green photoluminescence material, is applied or deposited (fabricated) as a uniform thickness layer directly onto and covers at least the principle (top as illustrated) light emitting face of an LED flip chip 322.

FIG. 4 shows a side view of a CSP double-layer photoluminescence structure light emitting device 410 in accordance with embodiments of the invention. In this embodiment, a first photoluminescence layer 426A containing narrowband red phosphor is applied or deposited (fabricated) as a uniform thickness layer directly onto and covers at least the principle (top as illustrated) light emitting face and four light emitting side faces of an LED flip chip 422. A second photoluminescence material layer 426B containing narrowband green photoluminescence material is applied or deposited (fabricated) as a uniform thickness layer onto and covers the top and side faces of the first photoluminescence layer 426A. In other embodiments, the first and second photoluminescence material layers 426A, 426B can be fabricated as a film and the film applied to one or more light emitting faces of the LED chip 422. As shown in FIG. 4, the first and second photoluminescence layers 426A, 426B can be in the form of a conformal coating.

KTF (K₂TiF₆:Mn⁴⁺) Phosphor

KTF phosphor is synthesized using a co-precipitation method. A first solution is prepared by dissolving potassium fluoride (KF) in aqueous hydrofluoric acid (HF). A second solution is prepared by dissolving a titanium (Ti) precursor and K₂MnF₆ in aqueous hydrofluoric acid. The first and second solutions are then mixed to co-precipitate K₂TiF₆:Mn⁴⁺ (KTF). The KTF is collected by, for example, filtering, washing, and then drying.

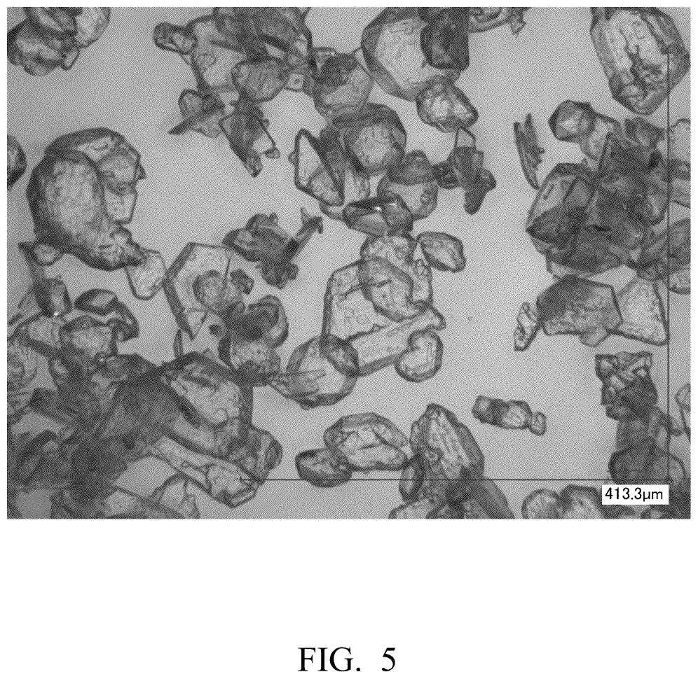

FIG. 5 is an optical micrograph of particles of K₂TiF₆:Mn⁴⁺ (KTF). It is to be noted that the micrograph shows that the particles of K₂TiF₆:Mn⁴⁺ (KTF) formed according to the present invention have a high degree of crystallinity (i.e., have clean facets) and are of a regular shape. As shown, the particles may be multi-faceted in form and may be described being substantially polyhedron in shape. As indicated in FIG. 5, the particle size is in a range from about 60 μm to about 120 μm. In contrast, known KTF particles have a low degree of crystallinity and are typically plate-like and of an irregular shape. The inventors have determined that the improved crystallinity of the KTF formed according to the present invention results in the KTF's improved reliability (stability) as well as its improved quantum efficiency (QE of about 97%) to values that are comparable with those of KSF (K₂SiF₆:Mn⁴⁺).

### Stability/Reliability Testing

Light emitting devices according to embodiments of the invention have been tested under accelerated testing conditions, known as “Wet High Temperature Operating Life” testing and referred to herein as WHTOL, in which the device is operated while being exposed to an environment 60° C./90% RH (relative humidity). A first device according to the invention, Dev.1, comprises an SMD 2835 package containing a combination of K₂TiF₆:Mn⁴⁺ narrowband red phosphor and β-SiAlON:Eu narrowband green phosphor. For comparison, a comparative light emitting device, Com.1, comprises an SMD 2835 package containing a combination of K₂SiF₆:Mn⁴⁺ narrowband red phosphor and β-SiAlON:Eu narrowband green phosphor. Both light emitting devices Dev.1 and Com.1 were subjected to WHTOL testing 60° C./90% RH while being operated at 120 mA.

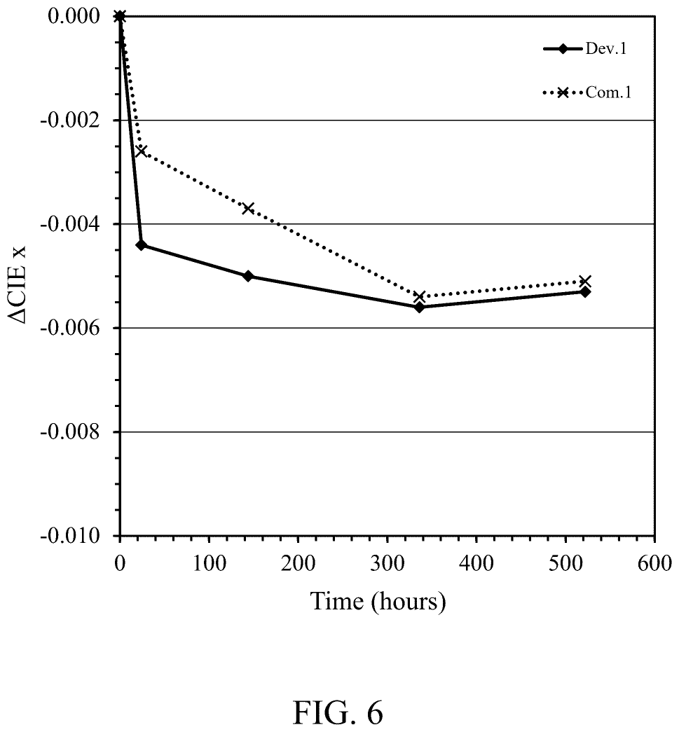

FIG. 6 shows reliability data, change of chromaticity ΔCIE x, (CIE x @ time t)-(CIE x @ time t=0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross). As can be seen from FIG. 6, the chromaticity CIE x of Dev.1-KTF and Com.1-KSF have changed (decreased) by less than 0.006 after 500 hours of accelerated testing and have plateaued. This shows a light emitting device according to embodiments of the invention incorporating KTF has, in terms of CIE x, as good as if not a superior stability than that of light emitting devices incorporating KSF, for instance.

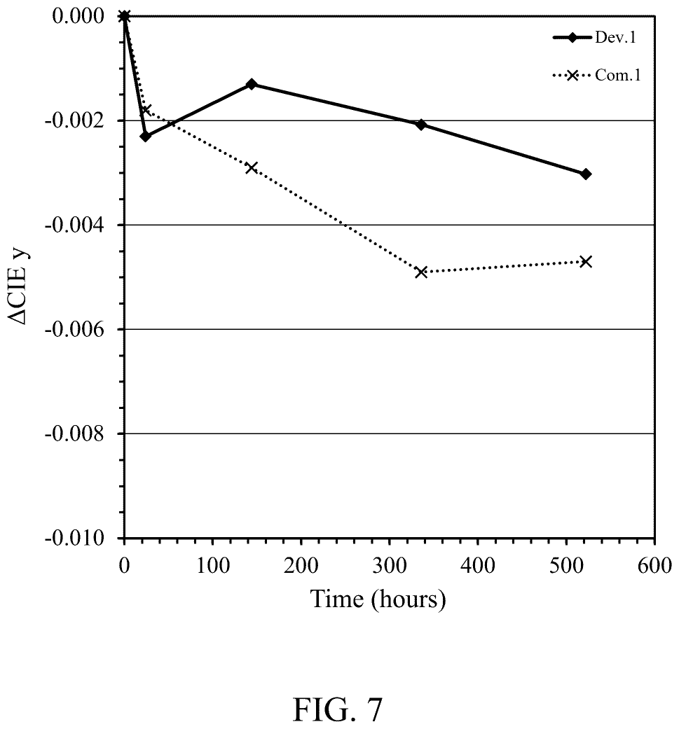

FIG. 7 shows reliability data, change of chromaticity ΔCIE y, (CIE y @ time t)-(CIE y @ time t=0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross). As can be seen from FIG. 7, the chromaticity CIE y of Dev. 1-KTF has changed (decreased) by less than 0.003 after 500 hours of accelerated testing. However, the chromaticity CIE y of Com.1-KSF has changed (decreased) by about 0.005 after 500 hours of accelerated testing and appears to be plateauing. This shows a light emitting device according to embodiments of the invention incorporating KTF has, in terms of CIE y, as good as if not a superior stability than that of light emitting devices incorporating KSF, for instance.

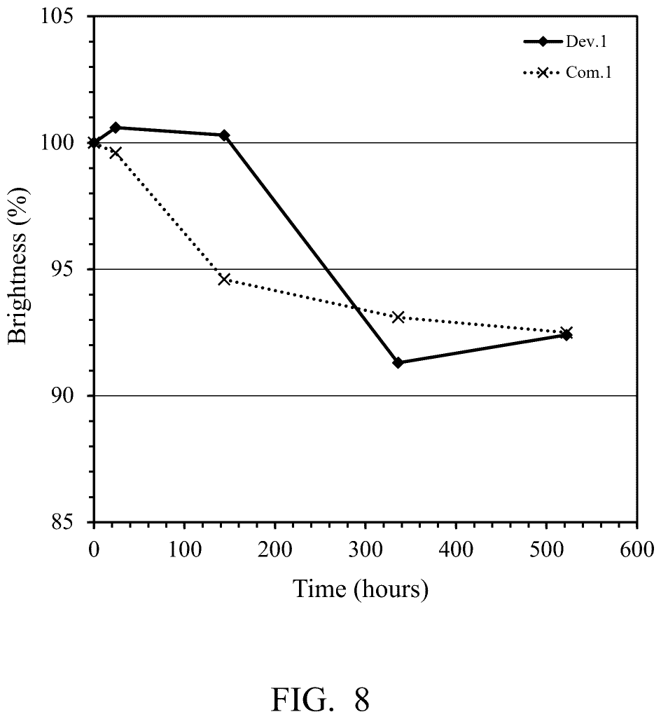

FIG. 8 shows reliability data, relative brightness, (Brightness @ time t)-(Brightness @ time t=0), versus time (hours), under accelerated testing conditions WHTOL 60° C./90% RH for (i) a light emitting device according to an embodiment of the invention Dev.1-KTF (solid line, solid diamond), and (ii) a comparative light emitting device Com.1-KSF (dotted line, cross). As can be seen from FIG. 8, the relative brightness of Dev.1-KTF and Com.1-KSF have decreased to about 92% of their starting brightness at time t=0 after 500 hours of accelerated testing and appear to be plateauing. This shows a light emitting device according to embodiments of the invention incorporating KTF has, in terms of brightness, as good as if not a superior reliability than that of light emitting devices incorporating KSF, for instance.

In summary, tests indicate that in terms of reliability (stability), light emitting devices in accordance with the invention that comprise K₂TiF₆:Mn⁴⁺ narrowband red phosphor have a reliability that is as good as light emitting devices that comprise K₂SiF₆:Mn⁴⁺. Moreover, while the stability of both devices are similar, light emitting devices in accordance with the invention that comprise K₂TiF₆:Mn⁴⁺ narrowband red phosphor have a much shorter decay time. The decay time of a light emitting device is determined by the slowest process of the device; in this instance, the decay time of the narrowband red phosphor. For example, K₂TiF₆:Mn⁴⁺ has a decay time of about 5 ms as compared with K₂SiF₆:Mn⁴⁺ which has a decay time of about 8 ms. For comparison, Eu activated phosphors such as β-SiAlON:Eu or SrGa₂S₄:Eu have a decay time of a few tens of microseconds (μs) and quantum dots a decay time in the nanosecond range (ns). For this reason, light emitting devices in accordance with the invention that comprise K₂TiF₆:Mn⁴⁺ narrowband red phosphor have a decay time of about 5 ms making them ideally suited to applications in which the lighting device is turned on and off rapidly, such as for displays for instance. For example, it is contemplated that lighting devices according to the invention find utility as a display backlight in a display having zone dimming in which zones (regions) of backlights are modulated to achieve dimming. Moreover, lighting devices of the invention find utility as a light source for an individual pixel or sub-pixel in for example micro-LED and OLED displays. In micro-LED and OLED displays, red sub-pixels may comprise an LED and KTF.

What is claimed is:

1. A light emitting device comprising:
a source for generating light with a dominant peak wavelength in a range from about 430 nm to about 480 nm; and
a manganese-activated narrowband red phosphor of general composition K₂TiF₆:Mn⁴⁺,
wherein light generated by the light emitting device has a change of chromaticity CIE x of less than 0.006 after operating for at least 500 hours in an environment of temperature 60° C. and relative humidity 90%.

2. The light emitting device of claim 1, wherein light generatable by the light emitting device has a reduction in brightness of less than 10% after operating for at least 500 hours in said environment, optionally light generatable by the light emitting device has a reduction in brightness of less than or equal to 8% after operating for at least 500 hours in said environment.

3. The light emitting device of claim 1, wherein light generatable by the light emitting device has a change of chromaticity CIE y of less than 0.005 after operating for at least 500 hours in said environment, optionally light generatable by the light emitting device has a change of chromaticity CIE y of less than or equal to 0.003 after operating for at least 500 hours in said environment.

4. The light emitting device of claim 1, wherein the manganese-activated narrowband red phosphor has a quantum efficiency of at least 90%.

5. The light emitting device of claim 1, wherein the manganese-activated narrowband red phosphor has a quantum efficiency of at least 95%.

6. The light emitting device of claim 1, wherein the manganese-activated narrowband red phosphor has a quantum efficiency of at least 97%.

7. The light emitting device of claim 1, wherein the manganese-activated narrowband red phosphor comprises particles with a high degree of crystallinity.

8. The light emitting device of claim 1, wherein the manganese-activated narrowband red phosphor comprises particles having clean facets.

9. The light emitting device of claim 1, wherein the manganese-activated narrowband red phosphor comprises particles with a regular shape.

10. The light emitting device of claim 1, wherein the manganese-activated narrowband red phosphor comprises particles are multi-faceted.

11. The light emitting device of claim 1, wherein the manganese-activated narrowband red phosphor comprises particles that are substantially polyhedron in shape.

12. The light emitting device of claim 1, wherein the manganese-activated narrowband red phosphor comprises particles of a size in a range from about 60 μm to about 120 μm.

13. The light emitting device of claim 1, wherein the manganese-activated narrowband red phosphor has a decay time of about 5 ms.

14. The light emitting device of claim 1, comprising a narrowband green photoluminescence material selected from the group consisting of: β-SiAlON:Eu phosphor, SrGa₂S₄ phosphor, and green quantum dot material.

15. A display comprising a light emitting device of claim 1.

16. The display of claim 15, wherein the light emitting device comprises a display backlight.

17. The display of claim 15, wherein the light emitting device comprises a display pixel.

18. A display backlight comprising:
a source for generating light with a dominant peak wavelength in a range from about 430 nm to about 480 nm;
a manganese-activated narrowband red phosphor of general composition K₂TiF₆:Mn⁴⁺; and a narrowband green photoluminescence material selected from the group consisting of: β-SiAlON:Eu phosphor, SrGa₂S₄ phosphor, and green quantum dot material.
